(19) United States
(12) Patent Application Publication
(10) Pub. No.: US 2018/0054322 A1
(43) Pub. Date: Feb. 22, 2018

(54) HOUSEHOLD APPARATUS, COMMUNICATION ADAPTER, CONTROL METHOD, AND RECORDING MEDIUM

(71) Applicant: Mitsubishi Electric Corporation, Tokyo (JP)

(72) Inventors: Naoyuki HIBARA, Tokyo (JP); Makoto HIRANO, Tokyo (JP); Hirotoshi YANO, Tokyo (JP)

(21) Appl. No.: 15/560,731

(22) PCT Filed: May 12, 2015
(86) PCT No.: PCT/JP2015/063582

§ 371 Date: Sep. 22, 2017

(51) Int. Cl. H04L 12/28; H04L 29/02; G05B 19/042

(52) U.S. Cl. CPC H04L 12/2829; H04L 29/02; G05B 2219/2613; H04L 2012/2841; H04L 2012/285; G05B 19/0423

(57) ABSTRACT

In the present disclosure, a procedure begins with an operation request from a communication terminal in step S301, and counting by a timer of a household apparatus starts in step S306. Processing of steps S311 to S314 is performed periodically when communication is possible between a controller and a communication adapter. That is, due to periodic resetting of the timer of the household apparatus in step S314, the timer does not time out. However, when communication between the controller and the communication adapter is not performed for some reason, the timer of the household apparatus afterward times out in step S321, and the household apparatus-transitions to a safe operation state in step S322.

### TECHNICAL FIELD

The present disclosure relates to technology for appropriately determining an uncontrollable state and causing a household apparatus to transition to a safe operation state.

### BACKGROUND ART

In recent years, popular home systems, such as energy management systems or the like, use a predetermined communication standard to connect to various types of electrical apparatuses and/or home apparatuses (referred to hereinafter collectively as “household apparatuses”) disposed within a household. Various types of household appliances, such as an air conditioner, a lighting apparatus, a rice cooker, an induction heating-type cooking apparatus, a dehumidifier, a circulation fan, and a hot water heater, for example, are connected in a communication-capable manner by such a home system, and the home system appropriately manages, that is, monitors and/or controls, each of the household apparatuses.

Recently a user while away from home is able to use a communication terminal, such as a smart phone or the like, to access such a home system from outside the home and to remotely operate the household apparatus. However, in practice communication may be interrupted due to worsening of a communication environment in the vicinity of the communication terminal, draining of a battery of the communication terminal, or the like, and remote operation may be disabled. Although under such circumstances generally the household apparatus continues to operate on the basis of the last received command of remote operation, allowing such operation to continue unconditionally may be unsafe.

As a leading technology of such a home system. Patent Literature 1, for example, discloses a home system that, upon disablement of remote operation, provides notification of the disablement within the home, and causes the household apparatus to transition to a safe operation state when an operation is not obtained from within the home.

### CITATION LIST

### Patent Literature

Patent Literature 1: Unexamined Japanese Patent Application Kokai Publication No. 2015-35647

### SUMMARY OF INVENTION

### Technical Problem

In the home system described in the aforementioned Patent Literature 1, the household apparatus is determined to be in the uncontrollable state based on detection of interruption of communication with the communication terminal, and the household apparatus is made to transition to the safe operation state. However, in recent home systems, the functions of the controller controlling the overall system are satisfactory, and appropriate control of the household apparatus is possible in response to a change in conditions 24 hours a day, regardless of whether the change occurs during the day or late at night. For example, the controller is capable of comprehensive control of the household apparatuses by, in addition to collecting information from the household apparatus (such as an operation state, power consumption, various types of alerts, and the like), collecting information from various types of sensors inside and outside the home (information such as temperature, humidity, illumination, vibration sensing, smoke sensing, gas sensing, intruder alert, and the like, for example). Thus even if there is an interruption in communication with the communication terminal, as long as communication is possible between the controller and the household apparatus, recently safe control of the household apparatus is still thought to be possible.

Further, in such home systems, the products of different manufacturers may be intermixed due to unification of communication standards or the like. For example, in a case in which the household apparatus and the controller are products of different manufacturers, even though the controller detects an interruption in communication with the communication terminal, there may be an inability to transmit to the household appliance the occurrence of the interruption. Thus appropriate determination by the household apparatus of the uncontrollable state is desired.

In consideration of the aforementioned circumstances, an objective of the present disclosure is to appropriately determine the uncontrollable state and to cause the household apparatus to transition to the safe operation state.

### Solution to Problem

In order to attain the aforementioned objective, the household apparatus of the present disclosure controlled by a remote operation via a network includes a state control unit configured to, when communication with a management apparatus requesting or mediating a remote operation is interrupted in a remote operation state, cause transition of the household apparatus to a predetermined safe operation state, the remote operation state being a state in which the remote operation is performed.

### Advantageous Effects of Invention

According to the present disclosure, the uncontrollable state can be appropriately determined, and the household apparatus can be made to transition to the safe operation state.

### BRIEF DESCRIPTION OF DRAWINGS

FIG. 1 is a schematic drawing illustrating an example of overall configuration of a home system according to an embodiment of the present disclosure;

FIG. 2 is a block diagram illustrating an example of configuration of a household apparatus;

FIG. 3 is a schematic drawing for description of an operation state of the household apparatus;

FIG. 4 is a block diagram illustrating an example of configuration of a communication adapter;

FIG. 5 is a schematic drawing illustrating an example of outside-home operation management information stored in a storage of the communication adapter;

FIG. 6 is a block diagram illustrating an example of configuration of a controller;

FIG. 7 is a flow chart illustrating an example of state management processing executed by the household apparatus;

FIG. 8 is a flow chart illustrating an example of communication management processing executed by the communication adapter;

FIG. 9 is a flow chart for description of overall operation of the home system;

FIG. 10 is a flow chart for description of overall operation of the home system, including accessing from another apparatus;

FIG. 11 is a flow chart for description of the overall operation of the home system, including an in-home operation from a remote control unit; and

FIG. 12 is a block diagram illustrating an example of configuration of a household apparatus according to another embodiment.

### DESCRIPTION OF EMBODIMENTS

Embodiments of the present description are described below in detail in reference to figures. In the figures, components that are the same or equivalent are assigned the same reference signs. Although the present disclosure below describes as a specific example the case of application to a household apparatus or the like in a home system, the present disclosure can similarly be applied to apparatuses in other systems. That is to say, the embodiment described below is for explaining the present disclosure, and does not limit the scope of the present disclosure. Thus although one skilled in the art can use embodiments replacing various or all elements by equivalents, such modified embodiments are included in the scope of the present disclosure.

### Embodiment

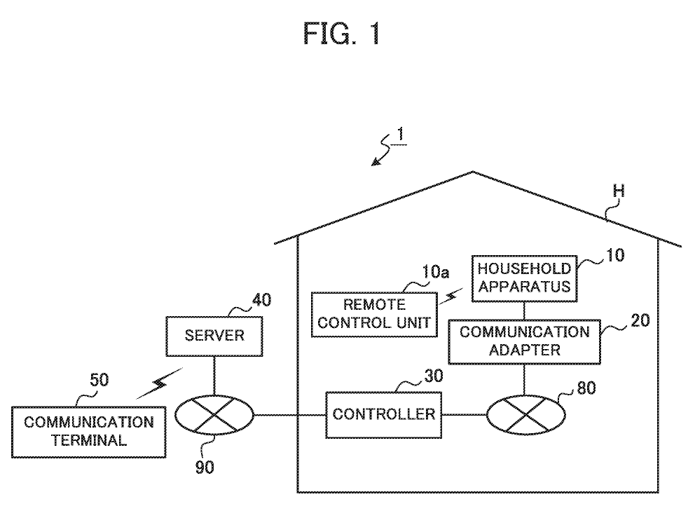

FIG. 1 is a schematic drawing illustrating an example of overall configuration of a home system 1 according to an embodiment of the present disclosure. This home system 1 is a system in which a user operates a communication terminal 50 from an outside location or the like (outside-home) and can remotely operate (an outside-home operation) a household apparatus 10 disposed in a home H (in-home). As illustrated, the home system 1 includes the household apparatus 10, a remote control unit 10a, a communication adapter 20, a controller 30, a server 40, and the communication terminal 50. Further, the communication adapter 20 and the controller 30 are interconnected via an in-home network 80 in a communication-capable manner. Also, the communication adapter 20 and the household apparatus 10 are connected via a connecting cable, a connecting connector, and the like. Further, the server 40 and the controller 30 are communicably interconnected through an external network 90. For ease of description in FIG. 1 a case is illustrated in which one unit each of the household apparatus 10, the controller 30, and the like are disposed in the home H; although actually multiple units of the household apparatus 10, the controller 30, and the like may be disposed in the home H.

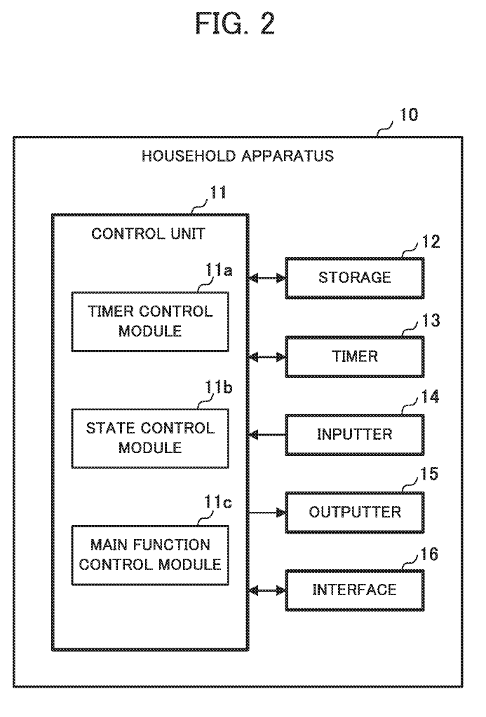

The household apparatus 10 is a home electric apparatus and/or home apparatus disposed in the home H, and specific examples of the household apparatus 10 include an air conditioner, a lighting apparatus, a rice cooker, an induction heating (IH) cooking heater, a dehumidifier, a circulation fan, a water heater, and the like. Further, some of the hot water heaters and the like described as apparatuses included in the household apparatuses 10 can be disposed outside the home H. The household apparatus 10 is furnished with, for example, the remote control unit 10a, and can receive operation commands from the remote control unit 10a. An example of configuration of the household apparatus 10 is described below in reference to FIG. 2.

As illustrated in FIG. 2, the household apparatus 10 includes a control unit 11, a storage 12, a timer 13, an inputter 14, an outputter 15, and an interface 16.

The control unit 11 includes, for example, a central processing unit (CPU), a read only memory (ROM), a random access memory (RAM), and the like (all not illustrated), and performs overall control of the household apparatus 10. The control unit 11 includes functions of a timer control module 11a, a state control module 11b, and a main function control module 11c. These functions are achieved by the CPU using the RAM as a working memory and appropriately executing various types of programs stored in the ROM, for example, such as a below-described program for the state management processing and the like.

The timer control module 11a controls operation of the timer 13 in response to various types of commands supplied from the inputter 14 and the interface 16. Further, the interface 16 supplies, as described below, an operation command by the outside-home operation, a notification command (explained below in detail, command for notification of normal communication), and the like. On the other hand, the inputter 14 supplies, as described below, an operation command by an in-home operation.

For example, when the operation command by the outside-home operation is supplied from the interface 16, the timer control module 11a causes the timer 13 to operate and start counting. Further, as described below in detail, the timer 13 during operation counts from an initial value up until a reference value is exceeded (timing-out). Further, upon the interface 16 supplying a notification command during counting by the timer 13, the timer control module 11a resets the count. That is to say, the timer control module 11a returns the count of the timer 13 to the initial value and causes the counting operation to continue. Further, upon the inputter 14 or the like supplying the operation command by the in-home operation during counting by the timer 13, the timer control module 11a causes the counting by the timer 13 to stop. That is to say, the timer control module 11a causes a halt of operation of the timer 13.

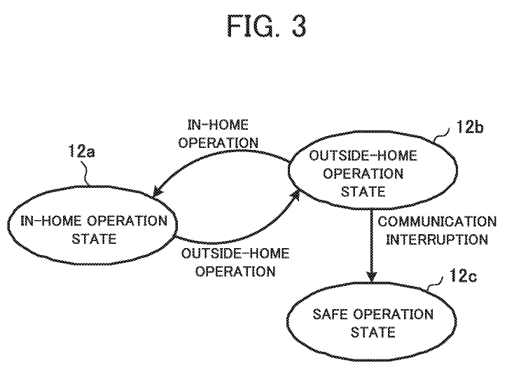

The state control module 11b controls the operation state of the household apparatus 10. Further, the household apparatus 10 is, as illustrated in FIG. 3, in one of the operation states such as an in-home operation state 12a, an outside-home operation state 12b, or a safe operation state 12c. Further, a stopped state (power OFF and the like) is omitted from FIG. 3. The in-home operation state 12a indicates the state of undergoing the in-home operation by the remote control unit 10a. The outside-home operation state 12b indicates the state of undergoing the outside-home operation by the communication terminal 50. The safe operation state 12c indicates the state in which a safe operation (suitable for safety) is performed, the safe operation being determined in response to the household apparatus 10, that is, in response to the type of apparatus or the like. Specifically, when the household apparatus 10 is the air conditioner, the safe operation is determined to be air blowing or stoppage. Further, when the household apparatus 10 is the hot water heater, the safe operation is determined to be stoppage. Further, when the household apparatus 10 is the circulation fan, the safe operation is determined to be low-power operation. Further, when the household apparatus 10 is the rice cooker, the safe operation is determined to be warming or stoppage. Further, each of such safe operations is an example, and the safe operation can be changed appropriately in response to the actual household apparatus 10.

In response to a received operation command, timing out of the timer 13, or the like, the state control module 11b sets (causes a transition of) the state of the household apparatus 10 to the in-home operation state 12a, the outside-home operation state 12b, or the safe operation state 12c. For example, in the outside-home operation state 12b, upon operation by the in-home operation, the state control module 11b causes a transition to the in-home operation state 12a. Conversely, in the in-home operation state 12a, upon operation by the outside-home operation, the state control module 11b causes a transition to the outside-home operation state 12b. Further, upon detection of the interruption of communication in the outside-home operation state 12b (case of occurrence of timing-out of the timer 13), the state control module 11b causes a transition to the safe operation state 12c.

Again in reference to FIG. 2, the main function control module 11c controls main functions of the household apparatus 10 in response to the operation command supplied from the inputter 14 or the interface 16; the main function being, for example, cooling, heating, dehumidifying, or the like in the case of the air conditioner, and being freezing, refrigerating, or the like in the case of the refrigerator. Further, when the safe control module 11b is in the safe operation state 12c, that is, when the timer 13 starts counting and then times out, the main function control module 11c controls the main function of the household apparatus 10 so that the household apparatus 10 is in the safe operation state.

The storage 12 is formed, for example, from memory such as non-volatile semiconductor memory and stores information concerning the household apparatus 10, an example of the information being the aforementioned operation state illustrated in FIG. 3. Further, the storage 12 also stores information such as programs executed by the control unit 11.

The timer 13 includes components such as, for example, a quartz oscillator, a counter, or the like, and counts a non-communication time (time of non-communication between the communication adapter 20 and the controller 30) in order to detect the interruption of communication occurring in the outside-home operation state (aforementioned outside-home operation state 12b of FIG. 3). That is to say, the timer 13 operates on the basis of the command of the aforementioned timer control module 11a and counts from the initial value until the reference value is exceeded, that is, until timing out. Specifically, in the case of the reference value being determined to be 24 hours, the timer 13 times out upon the count exceeding 24 hours. Further, this reference value is an example, and the reference value can be changed appropriately in response to the actual household apparatus 10.

Due to the timer 13 timing out in this manner, the interruption of communication is detected in the outside-home operation state. Thereafter, the aforementioned main function control module 11c or the like is notified of the detected interruption of communication. Further, the timer 13 resets the count in response to the command from the aforementioned timer control module 11a (in the case of sending of the notification command from the communication adapter 20 as described below), and the timer 13 stops the count (in the case of sending of the operation command by in-home operation as described below).

The inputter 14 includes, for example, an infrared receiver unit or the like, and receives the operation command, that is, the operation command by the in-home operation, sent from the remote control unit 10a. Further, in the case in which the household apparatus 10 is not furnished with the remote control unit 10a, the inputter 14 includes a plurality of input switches and the like, and receives the operation command in response to the user pressing down the switches. Whatever the configuration, the inputter 14 receives the operation command by the in-home operation and supplies the operation command to the control unit 11.

The outputter 15 includes, for example, a liquid crystal panel or the like, and displays the operation state or the like of the household apparatus 10.

The interface 16 includes, for example, an exterior-connection unit or the like, and connects to the communication adapter 20 via components such as the connecting cable and/or connecting connector. The interface 16 allows sending and receiving of various types of information between the interface 16 and the connected communication adapter 20. For example, the interface 16 receives the operation command and/or the notification command sent from the communication adapter 20 and supplies the operation command and/or the notification command to the control unit 11. Further, the operation commands sent from the communication adapter 20 includes the operation command by the outside-home operation from the communication terminal 50. Further, the interface 16 transmits to the communication adapter 20 state change information supplied from the control unit 11. For example, in the case of a change by the state control module 11b from the outside-home operation state to the in-home operation state (case of the in-home operation by the remote control unit 10a in the outside-home operation state 12b of FIG. 3), the interface 16 transmits to the communication adapter 20 the state change information indicating change from the outside-home operation state to the in-home operation state.

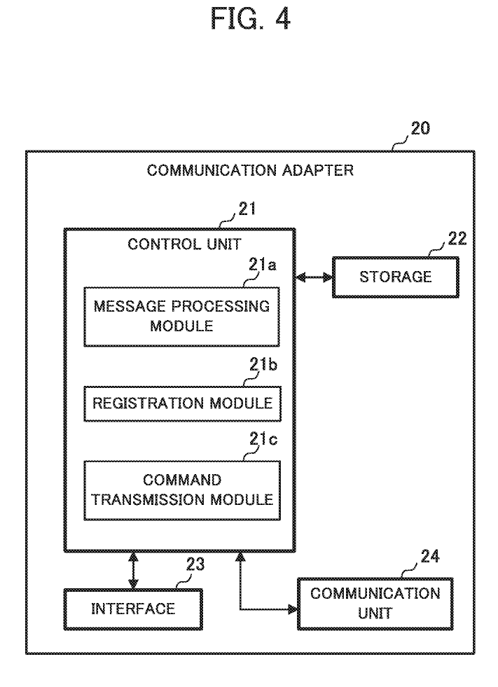

Again in reference to FIG. 1, the communication adapter 20 is an adapter for appending communication functions to the household apparatus 10. That is to say, by appending, that is, by connecting the communication adapter 20 to the household apparatus 10, the household apparatus 10 can communicate via the in-home network 80. An example of configuration of such a communication adapter 20 is described below in reference to a block diagram of FIG. 4. As illustrated in the figure, the communication adapter 20 includes a control unit 21, a storage 22, an interface 23, and a communication unit 24.

The control unit 21 includes, for example, a CPU, a ROM, a RAM, and the like (all not illustrated), and performs overall control of the communication adapter 20. The control unit 21 includes functions of a message processing module 21a, a registration module 21b, and a command transmission module 21c. These functions are achieved by the CPU using the RAM as a working memory and appropriately executing various types of programs stored in the ROM, for example, such as a below-described program for the communication management processing and the like. Further, the control unit 21 accesses the household apparatus 10 via the interface 23 periodically at a predetermined period, such as 1 minute, for example, and collects various types of information concerning the household apparatus 10, that is, causes storage of the various types of information in the storage 22.

The message processing module 21a processes the message, such as a communication frame, received from the communication unit 24, and if required, generates a reply message and causes transmission of the reply message by the communication unit 24. For example, the message processing module 21a processes the message of an operation request (the outside-home operation or the in-home operation) and generates the operation command for the household apparatus 10. Further, the message processing module 21a processes the message of a state acquisition request (state referral of the household apparatus 10), and generates a message of a state acquisition request reply from information concerning the household apparatus 10 stored in the storage 22. Thereafter, the message processing module 21a causes the message of the generated state acquisition request reply to be returned by the communication unit 24. Further, in the case in which the message of the processed state acquisition request is sent from the controller 30 via remote operation in the outside-home operation state (more specifically, in the case of matching an address of below-described management apparatus information), the message processing module 21a generates the notification command providing notification of normal communication to the household apparatus 10.

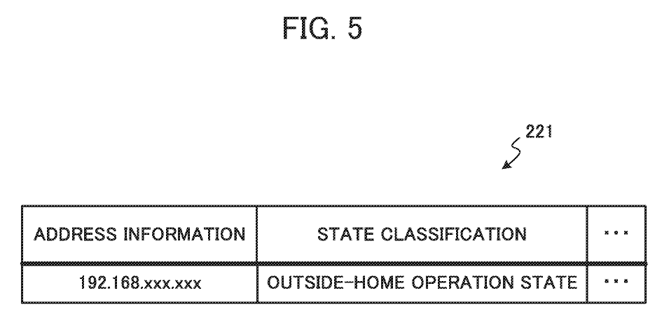

In the case in which the operation request processed by the message processing module 21a is by the outside-home operation from the communication terminal 50, the registration module 21b generates the management apparatus information for retaining the controller 30 mediating remote operation as the management apparatus, and the registration module registers the generated management apparatus information in the storage 22. Specifically, the registration module 21b generates management apparatus information 221 as illustrated in FIG. 5. This management apparatus information 221, for example, includes address information and a state classification. The address information is the address information of the controller 30 actually mediating remote operation, and even if a plurality of controllers 30 is assumed to exist on the in-home network 80, one of the controllers 30 can be identified to act as the management apparatus. Further, in addition to the address information, the management apparatus information 221 may further include intrinsic information such as a MAC address and the like. Further, the state classification indicates the operation state, such as the outside-home operation state, of the household apparatus 10. Further, upon the household apparatus 10 via the interface 23 sending the state change information indicating a prior change to the in-home operation state from the outside-home operation state, the registration module 21b may revise the state classification or may delete the management apparatus information 221 from the storage 22.

Again in reference to FIG. 4, the command transmission module 21c transmits to the household apparatus 10 via the interface 23 the operation command or the notification command generated by the message processing module 21a.

The storage 22 includes, for example, non-volatile semiconductor memory, and stores various types of information. For example, the storage 22 stores various types of information such as the aforementioned management apparatus information 221 illustrated in FIG. 5 or information concerning the household apparatus 10. Further, programs or the like executed by the control unit 21 are stored in the storage 22.

The interface 23, for example, includes an exterior-connection unit and the like, and connects to the household apparatus 10 via the connecting cable, connecting connector, or the like. The interface 23 causes exchange of various types of information with the connected household apparatus 10.

The communication unit 24 includes, for example, a communication unit such as a wired local area network (LAN), a wireless LAN, or the like, is under control by the control unit 21, and performs communication via the in-home network 80. For example, the communication unit 24 receives the message of the operation request (the outside-home operation or the in-home operation), or receives the message of the state acquisition request and transmits the message of the state acquisition request reply.

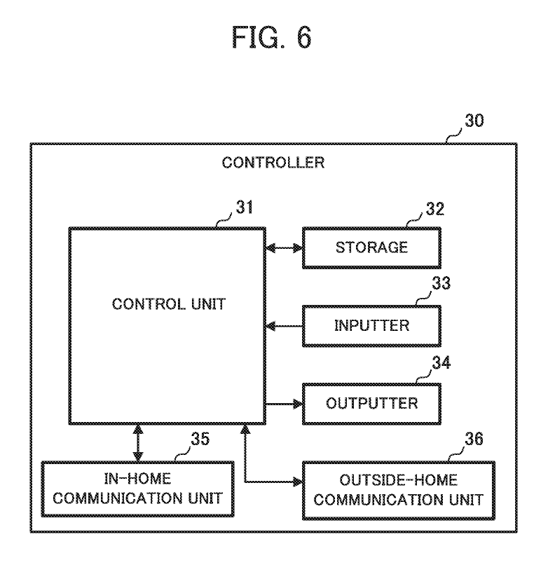

Again in reference to FIG. 1, the controller 30, for example, is a home energy management system (HEMS) controller controlling the household apparatus 10. The controller 30 functions as a gateway mediating remote operation (the outside-home operation) from the communication terminal 50. An example of configuration of the controller 30 is described below in reference to the block diagram of FIG. 6. As illustrated in the figure, the controller 30 includes a control unit 31, a storage 32, an inputter 33, an outputter 34, an in-home communication unit 35, and an outside-home communication unit 36.

The control unit 31, for example, includes a CPU, a ROM, a RAM, and the like (all not illustrated), and performs overall control of the controller 30. For example, upon receipt of the message of the operation request sent from the communication terminal 50 by the outside-home communication unit 36, the control unit 31 performs processing such as appending to the message the classification indicating the outside-home operation, and the control unit 31 causes transmission of the processed message from the in-home communication unit 35 to the communication adapter 20. Further, the control unit 31, as a periodic operation (for example, every 10 minutes), generates the message of the state acquisition request and causes transmission of the generated message from the in-home communication unit 35 to the communication adapter 20.

The storage 32 includes, for example, a non-volatile semiconductor memory, and stores various types of information. For example, the storage 32 stores information such as address information required for accessing the communication adapter 20 and/or the server 40. Further, programs or the like executed by the control unit 31 are stored in the storage 32.

The inputter 33 includes a plurality of input switches and the like, and receives the operation command in response to the user pressing down the switches.

The outputter 34 includes, for example, a liquid crystal panel or the like, and displays the operation state or the like of the controller 30.

The in-home communication unit 35 includes, for example, a communication unit such as a wired LAN or wireless LAN, undergoes control by the control unit 31, and performs communication via the in-home network 80.

The outside-home communication unit 36 includes, for example, an asymmetric digital subscriber line (ADSL) modem, a cable modem for connection to the internet using an optical cable circuit, or the like, undergoes control by the control unit 31, and performs communication via the external network 90.

Again in reference to FIG. 1, the server 40 is a server computer capable of communication with the communication terminal 50 and/or the controller 30 via the external network 90. The server 40, for example, stores various types of information for identifying a user under contract, examples of such information being names of registered users, registered passwords, identification information of the communication terminal 50, identification information of the controller 30, and the like. Further, after performance of a predetermined verification processing between the server 40 and the communication terminal 50, the server 40 establishes a communication connection with the controller 30 on the basis of information such as set connection information. In this state, the server 40 transmits to the household apparatus 10 (communication adapter 20) via the controller 30 the message (such as the operation request by the outside-home operation) sent from the communication terminal 50.

The communication terminal 50 is a mobile-type communication terminal, for example, such as a smart phone, and is used by the user at a location such as an outside location, that is, an outside-home location. The communication terminal 50 includes components such as a communication interface capable of connecting to the external network 90, and transmits the message (such as the operation request by the outside-home operation) to the household apparatus 10 (the communication adapter 20) via the server 40 and the like. For example, the communication terminal 50 accesses the server 40 on the external network 90, and after performing a predetermined identification processing, causes establishment of a communication connection between the server 40 and the controller 30. In this state, the communication terminal 50 transmits the message to the household apparatus 10 (the communication adapter 20) via the server 40 and the controller 30. That is to say, the communication terminal 50 makes possible remote operation (the outside-home operation) of the household apparatus 10 from outside the home in this manner.

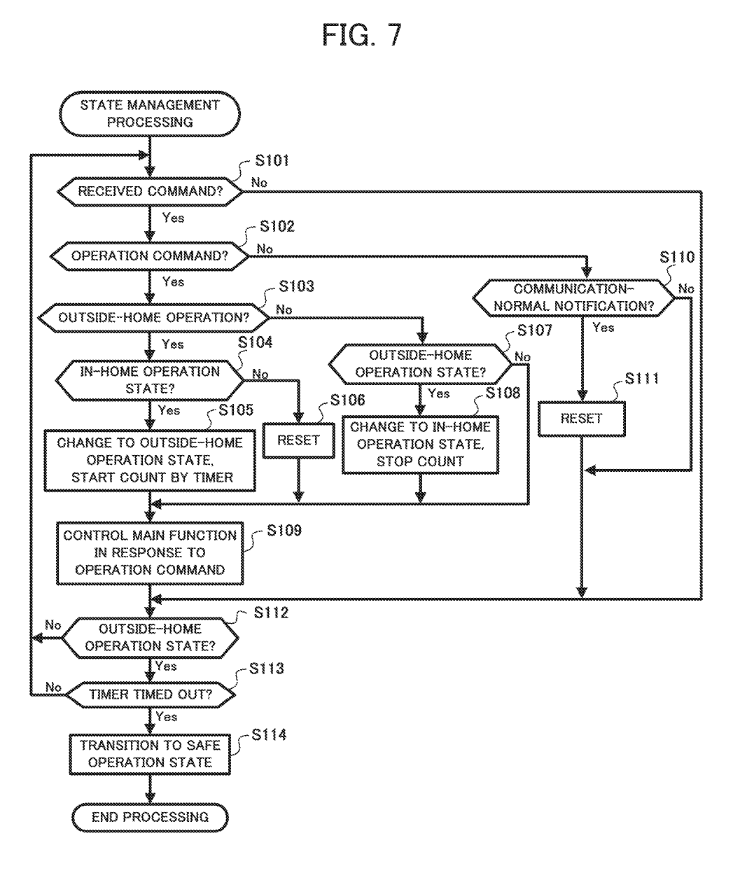

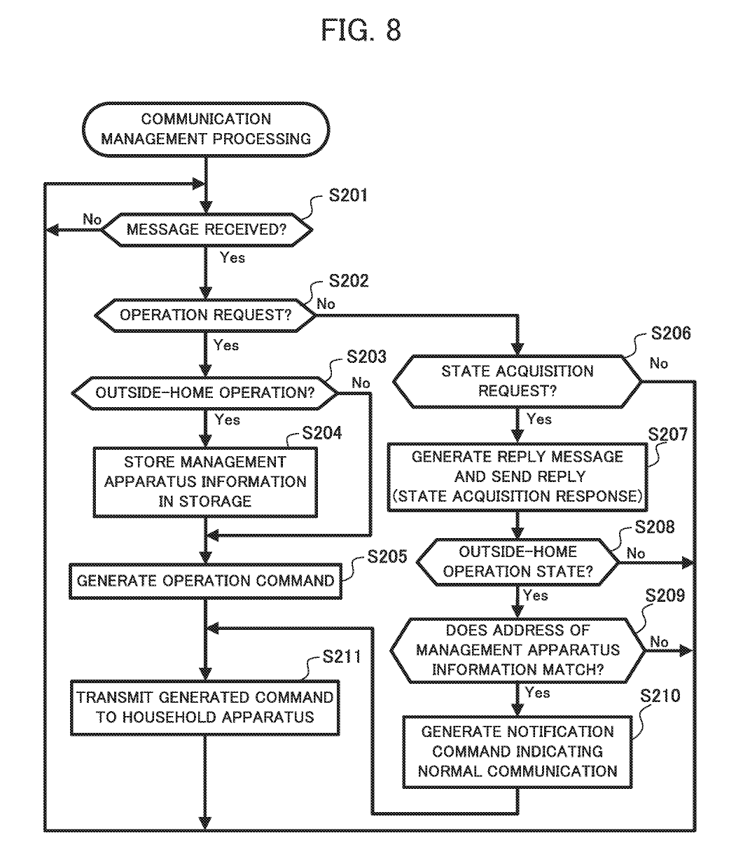

Operation of the home system 1 configured in this manner is described below in reference to FIG. 7 and FIG. 8. FIG. 7 is a flow chart illustrating an example of the state management processing executed by the household apparatus 10 (control unit 11). Further. FIG. 8 is a flow chart illustrating an example of communication management processing executed by the communication adapter 20 (control unit 21). Firstly, the state management processing of FIG. 7 is described.

Firstly, the control unit 11 of the household apparatus 10 determines whether there is prior reception of a command (step S101). That is to say, the control unit 11 determines whether there is prior reception of the command from the inputter 14 or the interface 16. Upon determination that there is no prior reception of the command (NO in step S101), the processing of the control unit 11 advances to a below-described step S112.

On the other hand, in the case of determination that there is prior reception of the command (YES in step S101), the control unit 11 determines whether the received command is an operation command (step S102). Upon determination that the received command is the operation command (YES in step S102), the control unit 11 determines whether the operation command is by the outside-home operation (step S103).

Upon determination that the operation command is by the outside-home operation (YES in step S103), the control unit 1 refers to the storage 12, and determines whether the present operation state is the in-home operation state (step S104). Upon determination that the present operation state is the in-home operation state (YES in step S104), the control unit 11 changes the operation state to the outside-home operation state, and causes a start of counting by the timer 13 (step S105). That is to say, the timer control module 11a operates the timer 13 and causes the start of counting of the non-communication time in order to detect the interruption of communication during the outside-home operation state.

On the other hand, in the case of determination that the present operation state is not the in-home operation state, that is, upon determination that the present operation state is the outside-home operation state (NO in step S104), the control unit 11 resets the count of the timer 13 (step S106). That is to say, due to in-progress running of the timer 13, the timer control module 11a causes the count of the timer 13 to return to the initial value, and causes continuation of the counting operation.

In the aforementioned step S103, in the case of determination that the operation is not the outside-home operation, that is, in the case of determination that the operation is the in-home operation (NO in step S103), the control unit 11 determines whether the present operation state is the outside-home operation state (step S107). Upon determination that the present operation state is not the outside-home operation state, that is, upon determination that the present operation state is the in-home operation state (NO in step S107), processing by the control unit 11 proceeds to a below-described step S109.

On the other hand, in the case of determination that the present operation state is the outside-home operation state (YES in step S107), the control unit 11 causes a change of the operation state to the in-home operation state, and causes the counting to stop (step S108). That is to say, the timer control module 11a causes operation of the timer 13 to stop.

The control unit 11 controls the main functions in response to the operation command (step S109). That is to say, in response to the operation command supplied from the inputter 14 or the interface 16, the main function control module 11c controls the main function of the household apparatus 10; the main function being, for example, cooling, heating, dehumidifying, or the like in the case of the air conditioner, and being freezing, refrigerating, or the like in the case of the refrigerator.

In the case of determination in the aforementioned step S102 that the received command is not the operation command (NO in step S102), the control unit 11 determines whether the received command is a communication-normal notification, that is, a command for notification of normal communication (step S110). Upon determination that there is no communication-normal notification (NO in step S110), processing by the control unit 11 proceeds to a below-described step S112.

On the other hand, in the case of determination that the received command is the communication-normal notification (YES in step S110), the control unit 11 resets the counter of the timer 13 (step S111). That is to say, the timer control module 11a causes a return of the count of the timer 13 to the initial value, and causes continuation of the counting operation.

The control unit 11 determines whether the present operation state is the outside-home operation state (step S112). Upon determination that the present operation state is not the outside-home operation state, that is, upon determination that the present operation is the in-home operation state (NO in step S112), processing of the control unit 11 returns to the aforementioned step S101.

On the other hand, in the case of determination that the present operation state is the outside-home operation state (YES in step S112), the control unit 11 determines whether the timer 13 is timed out (step S113). Upon determination that the timer 13 is not timed out (NO in step S113), processing of the control unit 11 returns to the aforementioned step S101.

On the other hand, in the case of determination that the timer 13 is timed out (YES in step S113), the control unit 11 causes a transition to the safe operation state (step S114). That is to say, due to the detection of the interruption of communication during the outside-home operation state, the main function control module 11c causes the main function of the household apparatus 10 to transition to the safe operation state.

Communication management processing of FIG. 8 executed by the communication adapter 20 (control unit 21) is described below.

Firstly, the control unit 21 of the communication adapter 20 determines whether there is prior reception of the message (step S201). Further, upon determination that there is no reception of the message (NO in step S201), the control unit 21 repeats the determination until reception of the message.

On the other hand, in the case of determination that there is prior reception of the message (YES in step S201), the control unit 21 determines whether the received message is the operation request (step S202). Upon determination that the received message is the operation request (YES in step S202), the control unit 21 determines whether the message is by the outside-home operation (step S203). Upon determination that the message is not received by the outside-home operation, that is, determination that the message is by the in-home operation (NO in step S203), processing of the control unit 21 proceeds to the processing of a below-described step S205. Further, in the case in which the management apparatus information (management apparatus information 221 as illustrated in FIG. 5) is recorded in the storage 22, the management apparatus information is erased from the storage 22, or alternatively, rather than erasing the management apparatus information, the state classification of the management apparatus information 221 as illustrated in FIG. 5 may be changed from the outside-home operation state to the in-home operation state.

On the other hand, upon determination that the message is received by the outside-home operation (YES in step S203), the control unit 21 records the management apparatus information in the storage 22 (step S204). That is to say, the registration module 21b generates the management apparatus information in order to retain the controller 30 mediating remote operation as the management apparatus, and the registration module 21b records the management apparatus information in the storage 22. Further, when the management apparatus information is previously recorded in the storage 22, the control unit 21 overwrites the management apparatus information.

The control unit 21 generates the operation command (step S205). That is to say, the message processing module 21a generates the operation command in response to the message of the operation request (the outside-home operation or the in-home operation).

In the case of determination in the aforementioned step S202 that the received message is not the operation request (NO in step S202), the control unit 21 determines whether the received message is the state acquisition request (step S206). Upon determination that the received message is not the state acquisition request (NO in step S206), processing of the control unit 21 returns to the aforementioned step S201.

On the other hand, in the case of determination that the received message is the state acquisition request (YES in step S206), the control unit 21 generates and transmits a reply message (step S207). That is to say, the message processing module 21a processes the message of the state acquisition request and generates the message of the state acquisition request reply from information concerning the household apparatus 10 stored in the storage 22. Then the message processing module 21a causes the communication unit 24 to reply by transmitting the message of the generated state acquisition request reply.

The control unit 21 refers to the storage 22 and determines whether the household apparatus 10 is in the outside-home operation state (step S208). Upon determination that the household apparatus 10 is not in the outside-home operation state (NO in step S208), processing of the control unit 21 returns to the aforementioned step S201.

On the other hand, in the case of determination that the household apparatus 10 is in the outside-home operation state (YES in step S208), the control unit 21 determines whether the transmission source of the message matches the address of the management apparatus information (step S209). That is to say, the control unit 21 determines whether the address of the transmission source of the processed message of the state acquisition request matches the address information of the management apparatus information, that is, the management apparatus information 221 illustrated in FIG. 5, recorded in the storage 22. Upon determination of non-matching of the address of the management apparatus information (NO in step S209), processing of the control unit 21 returns to the aforementioned step S201.

On the other hand, in the case in which there is determined to be matching of the address of the management apparatus information (YES in step S209), the control unit 21 generates the notification command indicating normal communication (step S210).

The control unit 21 transmits the generated command to the household apparatus 10 (step S211). That is to say, the command transmission module 21c, via the interface 23, transmits to the household apparatus 10 the operation command generated in step S205 or step S210.

Then processing of the control unit 21 returns to the aforementioned step S201.

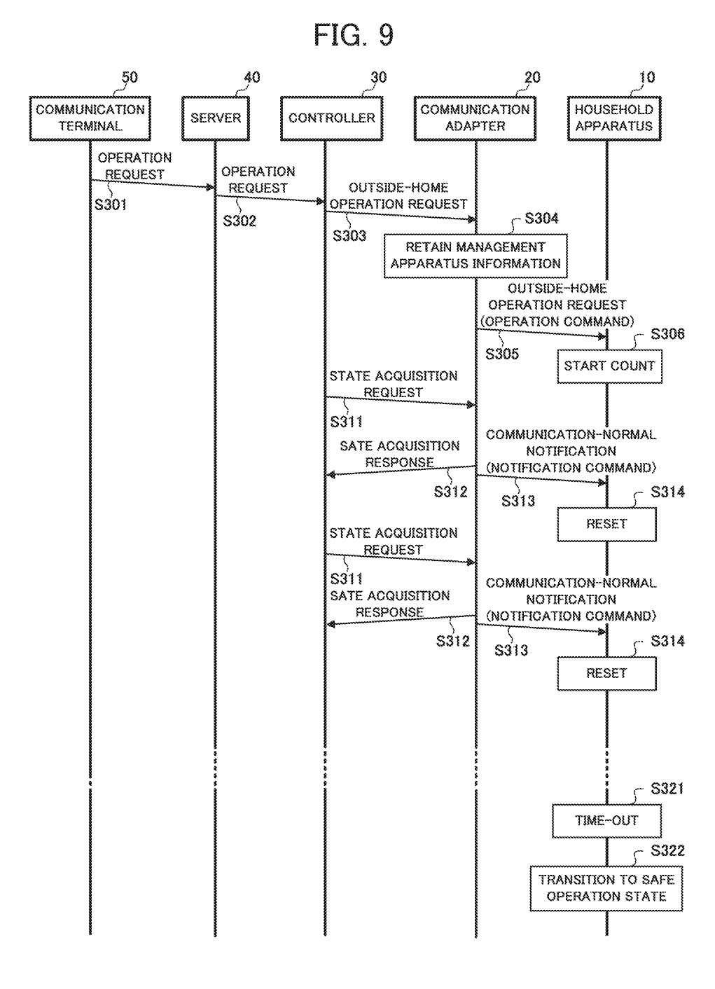

Overall operation in the home system 1 including such processing is described below in reference to flow charts of FIG. 9 to FIG. 11. Firstly, conditions from the detection of the interruption of communication until the transition to the safe operation state are described in reference to the flow chart of FIG. 9.

Firstly, the communication terminal 50 transmits the message of the operation request to the server 40 (step S301). Thereafter, the server 40 transmits the message of the operation request to the controller 30 (step S302).

The controller 30 sends to the communication adapter 20 the message of the outside-home operation request obtained by processing the message of the operation request (step S303). That is to say, upon reception of the message of the operation request by the outside-home communication unit 36, the control unit 31 of the controller 30 performs processing such as the appending to the message of a classification indicating the outside-home operation, and the control unit 31 of the controller 30 causes transmission of the processed message (message of the outside-home operation request) from the in-home communication unit 35 to the communication adapter 20.

The communication adapter 20 retains the management apparatus information (step S304). That is to say, the control unit 21 of the communication adapter 20 generates and records in the storage 22 the management apparatus information (management apparatus information 221 as illustrated in FIG. 5) for retention of the controller 30 mediating remote operation as the management apparatus.

The communication adapter 20 transmits the outside-home operation request (operation command) to the household apparatus 10 (step S305). That is to say, the control unit 21 of the communication adapter 20 generates the operation command in response to the outside-home operation request and transmits the generated operation command to the household apparatus 10 via the interface 23.

The household apparatus 10 starts counting (step S306). That is to say, the control unit 11 of the household apparatus 10 causes the timer 13 to operate and start to count the non-communication time in order to detect the interruption of communication in the outside-home operation state.

The controller 30 transmits the message of the state acquisition request to the communication adapter 20 (step S311). That is to say, the control unit 31 of the controller 30, as a periodic operation, generates the message of the state acquisition request and causes transmission of the generated message from the in-home communication unit 35 to the communication adapter 20.

The communication adapter 20 transmits the message of the state acquisition reply to the controller 30 (step S312). That is to say, the control unit 21 of the communication adapter 20 generates the message of the state acquisition request reply from information concerning the household apparatus 10 stored in the storage 22, and causes the generated message to be returned to the communication unit 24.

Further, the communication adapter 20 transmits the communication-normal notification (notification command) to the household apparatus 10 (step S313). That is to say, the control unit 21 of the communication adapter 20, after confirming that the address of the transmission source of the message of the processed state acquisition request matches the address information of the management apparatus information (management apparatus information 221 illustrated in FIG. 5) stored in the storage 22, generates the notification command indicating normal communication and transmits the generated notification command via the interface 23 to the household apparatus 10.

The household apparatus 10 resets the count (step S314). That is to say, the control unit 11 of the household apparatus 10 returns the count of the timer 13 to the initial value and causes continuation of the counting operation.

The processing of these steps S311 to S314 may be performed periodically (for example, every 10 minutes) when communication is possible between the controller 30 and the communication adapter 20. Thus due to periodic resetting of the count by the timer 13 of the household apparatus 10 in step S314, the timer 13 does not time out.

On the other hand, when communication between the controller 30 and the communication adapter 20 is not performed for some reason, the timer 13 of the household apparatus 10 afterward times out (step S321). Upon the occurrence of the time-out, the household apparatus 10 transitions to the safe operation state (step S322). That is to say, due to detection of the interruption of communication during the outside-home operation state, the control unit 11 of the household apparatus 10 causes the main function of the household apparatus 10 to transition to the safe operation state.

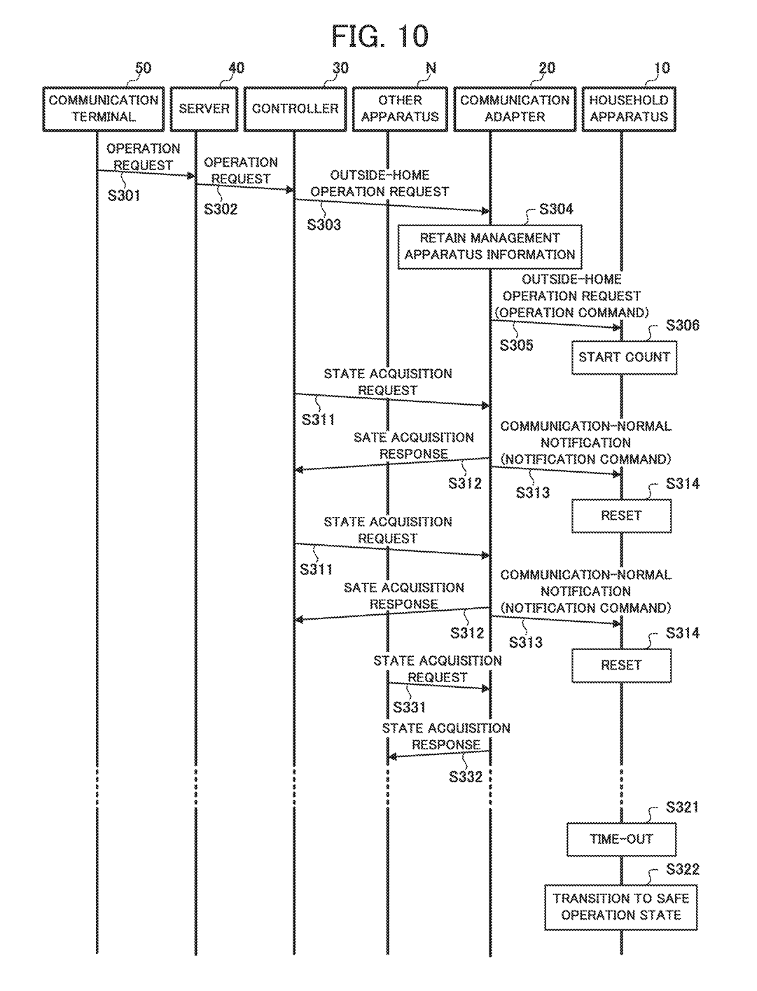

Conditions in the case of the presence of a plurality of controllers 30 on the in-home network 80 are described below in reference to the flow chart of FIG. 10. Further, another apparatus N in FIG. 10 indicates the controller 30 that does not mediate the outside-home operation from the communication terminal 50. Further, the controller 30 in FIG. 10 indicates the controller 30 mediating the outside-home operation from the communication terminal 50.

In a manner similar to FIG. 9, beginning in FIG. 10 with the operation request (transmission of the operation request message) from the communication terminal 50 in step S301, the count by the timer 13 of the household apparatus 10 starts in step S306.

Further, in a manner similar to FIG. 9, the processing of the steps S311 to S314 is performed periodically when communication is possible between the controller 30 and the communication adapter 20. After confirming that the address of the transmission source of the processed message of the state acquisition request matches the address information of the management apparatus information stored in the storage 22, the control unit 21 of the communication adapter 20 in step S313 transmits the communication-normal notification (notification command) to the household apparatus 10.

Thus even when the other apparatus N (that is, the controller 30 not mediating the outside-home operation from the communication terminal 50) transmits to the communication adapter 20 the message of the state acquisition request (step S331), although the communication adapter 20 replies by sending the message of the state acquisition reply (step S332), the communication adapter 20 does not transmit the communication-normal notification (notification command) to the household apparatus 10.

By this means, even if communication is performed between the other apparatus N and the communication adapter 20, when communication is not performed between the controller 30 (that is, the controller 30 mediating the outside-home operation from the communication terminal 50) and the communication adapter 20, the timer 13 of the household apparatus 10 times out in step S321 similarly to FIG. 9, and the household apparatus 10 in step S322 transitions to the safe operation state.

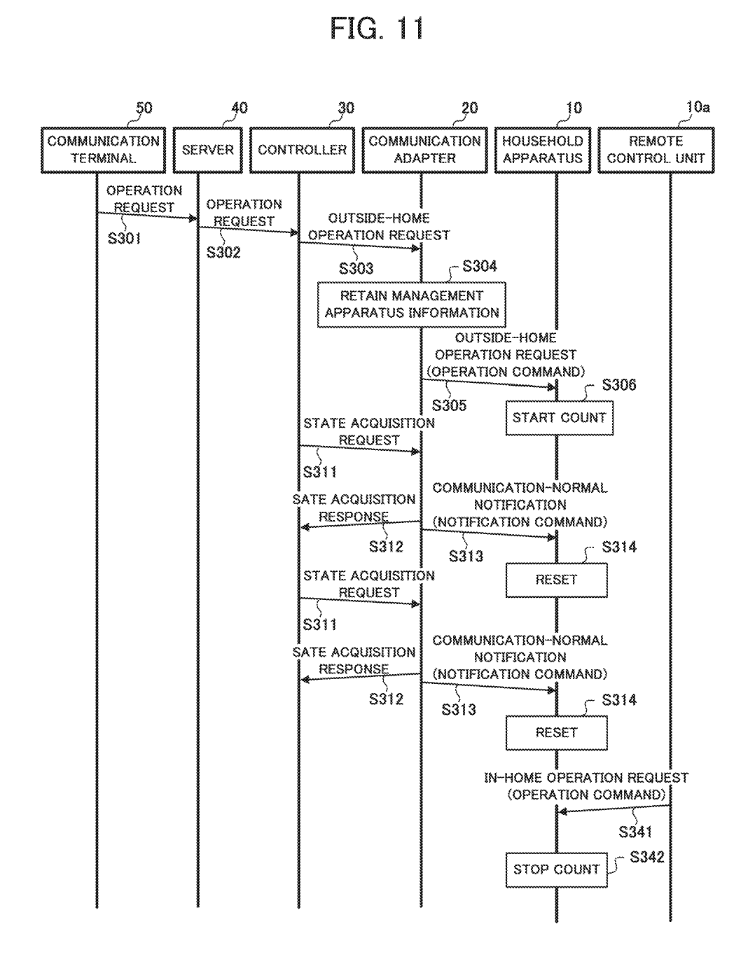

Conditions in the case of performance of the in-home operation are described next in reference to the flow chart of FIG. 11.

In FIG. 11, beginning with the operation request (transmission of the operation request message) from the communication terminal 50 in step S301 similarly to FIG. 9, counting by the timer 13 of the household apparatus 10 starts in step S306.

Further, similarly to FIG. 9, the processing of steps S311 to S314 is performed periodically when communication is possible between the controller 30 and the communication adapter 20. Thus the timer 13 does not time out.

When the in-home operation request (operation command) from the remote control unit 10a is sent to the household apparatus 10 in this state (step S341), the household apparatus 10 stops the count by the timer 13 (step S342). That is to say, due to performing of the in-home operation in the outside-home operation state, the control unit 11 of the household apparatus 10 causes a stoppage of operation of the timer 13.

Further, although FIG. 11 illustrates the case in which the in-home operation is performed from the remote control unit 10a, the household apparatus 10 stops the count of the timer 13 similarly to step S342 also in the case in which the operation command by the in-home operation is sent through the communication adapter 20 from any of the apparatuses on the in-home network 80.

In this manner, in response to communication conditions with the controller 30 mediating the outside-home operation, the household apparatus 10 is able to determine the interruption of communication. That is to say, whatever the communication condition with the communication terminal 50 performing the outside-home operation, the interruption of communication with the controller 30 (controller 30 mediating the outside-home operation) capable of stably controlling the household apparatus 10 is determined, and there is a transition to the safe operation state. As a result, the uncontrollable state is appropriately determined, and the household apparatus 10 can be made to transition to the safe operation state.

### Other Embodiments

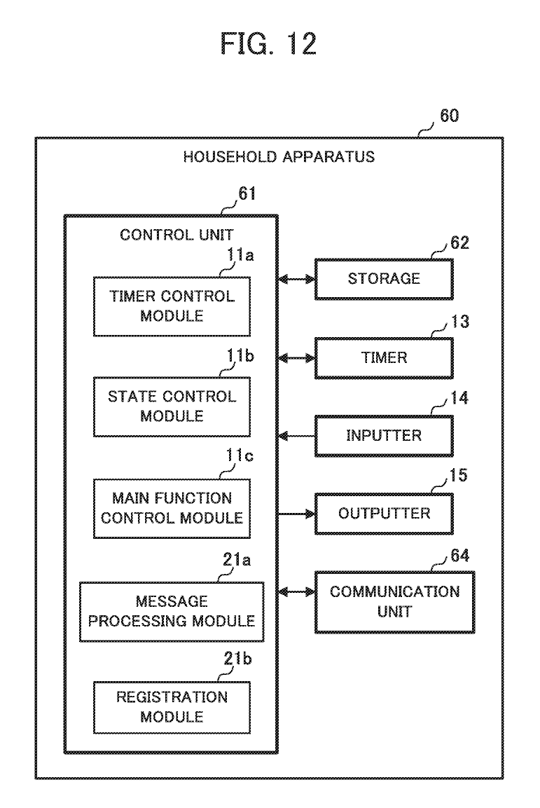

Although in the above embodiment the case is described in which the household apparatus 10 performs communication through the communication adapter 20, the household apparatus 10 may have a communication function without using the communication adapter 20. A household apparatus 60 having the communication function is described below in reference to FIG. 12.

As illustrated in FIG. 12, the household apparatus 60 includes a control unit 61, a storage 62, the timer 13, the inputter 14, the outputter 15, and a communication unit 64. Further, the timer 13 through the outputter 15 components are configured similarly to such components of the aforementioned household apparatus 10 of FIG. 2.

The control unit 61, for example, includes a CPU, a ROM, a RAM, and the like, all not illustrated, and performs overall control of the household apparatus 60. The control unit 61 includes functions of the timer control module 11a, the state control module 11b, the main function control module 11c, the message processing module 21a and the registration module 21b. These functions are achieved by the CPU using the RAM as a working memory and appropriately executing, for example, various types of programs stored in the ROM.

The timer control module 11a through the main function control module 11c components are configured similarly to the aforementioned household apparatus 10 of FIG. 2. Further, the timer control module 11a controls the operation of the timer 13 in response to the message (operation request or state acquisition request) processed by the message processing module 21a. Further, the state control module 11b controls the operation state of the household apparatus 10 in response to the message (operation request) processed by the message processing module 21a, timing out of the timer 13, or the like. Further, the main function control module 11c controls the main function of the household apparatus 10 in response to the message (operation request) processed by the message processing module 21a.

On the other hand, the message processing module 21a and the registration module 21b are configured in the same manner as the aforementioned communication adapter 20 of FIG. 4. Further, the message processing module 21a processes the message (operation request message or state acquisition request message) received by the communication unit 64. In the case in which the message of the operation request is processed, the message processing module 21a controls the main function control module 11c in response to the operation request.

In addition to storage of the aforementioned information stored by the storage 12 of the household apparatus 10, the storage 62 stores information such as the aforementioned management apparatus information 221 illustrated in FIG. 5.

The communication unit 64 includes, for example, a communication unit such as the wired LAN, the wireless LAN, and the like, undergoes control by the control unit 61, and performs communication via the in-home network 80. For example, the communication unit 64 receives the message of the operation request (the outside-home operation or the in-home operation) and/or the message of the state acquisition request, and transmits the message of the state acquisition request reply.

The household apparatus 60 configured in this manner determines interruption of communication, the determination being in response to the communication state with the controller 30 mediating the outside-home operation. That is to say, whatever the condition of communication with the communication terminal 50 performing the outside-home operation, the interruption of communication with the controller 30 (controller 30 mediating the outside-home operation) capable of stable control of the household apparatus 10 is determined, and the operation state transitions to the safe operation state. As a result, the uncontrollable state can be appropriately determined, and the household apparatus 10 can be made to transition to the safe operation state.

Although a case is described in the aforementioned embodiments in which the communication connection of the communication terminal 50 with the controller 30 is established through the server 40, the communication terminal 50 may establish the communication connection directly with the controller 30 without using the server 40 in this manner.

Although a case is described in the aforementioned embodiments in which the sending of the operation request (the outside-home operation) from the communication terminal 50 is a required condition for recording of the management apparatus information and the determination of the interruption of communication, sending of operation requests entirely through the in-home network 80, rather than just the outside-home operation, may be the required condition for recording of the management apparatus information and determining the interruption of communication. Although a case is described below in which the household apparatus 10 performs communication through the communication adapter 20, the aforementioned household apparatus 60 having the communication function can be also used appropriately in a similar manner.

Firstly, a case is described in which the communication adapter 20 receives the message of the operation request. In this case, the control unit 21 performs the aforementioned communication management processing of FIG. 8 except for change of only a portion of the processing. Upon determination in step S202 that the received message is the operation request (YES in step S202), the control unit 21 skips the determination of step S203, and in step S204, generates the management apparatus information (management apparatus information 221 illustrated in FIG. 5) and records the generated management apparatus information in the storage 22. That is to say, the registration module 21b generates and records in the storage 22 the management apparatus information for retaining as the management apparatus the controller 30 requesting or mediating remote operation.

Further, the control unit 21 generates the operation command in step S205. At this time, even in the case in which the operation request is by the in-home operation, the message processing module 21a unconditionally generates the operation command by the outside-home operation. Thereafter, the control unit 21 in step S211 transmits the generated command (operation command) to the household apparatus 10.

On the other hand, the household apparatus 10 (control unit 11) can execute the aforementioned state management processing of FIG. 7 as is. Further, all the operation commands sent from the communication adapter 20 are the operation commands entirely by the outside-home operation, and only the operation commands sent from the remote control unit 10a are the operation commands by the in-home operation. Thus when the operation command is sent from the communication adapter 20, the control unit 11 in step S105 of FIG. 7 causes the change of the operation state to the outside-home operation state and causes the start of the count by the timer 13. That is to say, due to detection of the interruption of communication in the remote operation state, the timer control module 11a causes operation of the timer 13 and causes the counting of the non-communication time to start.

Next, the case is described in which the communication adapter 20 receives the message of the state acquisition request. In this case, upon determination in step S206 of FIG. 8 that the received message is the state acquisition request (YES in step S206), the control unit 21 in step S207 produces the reply message, sends the produced message in reply, and in step S209, determines whether there is a match between the transmission source of the message and the address of the management apparatus information. That is to say, the control unit 21 determines whether there is a match between the address of the transmission source of the message of the state acquisition request and the address information of the management apparatus information (that is, the controller 30 requesting or mediating remote operation) recorded in the storage 22. Thereafter, in the case in which the determination is that there is a match (YES in step S209), in step S210, the control unit 21 generates the notification command and transmits the generated notification command to the household apparatus 10 in step S211.

On the other hand, upon receiving the notification command sent from the communication adapter 20, the household apparatus 10 (control unit 11) in step S110 of FIG. 7 determines whether the notification command is the communication-normal notification (notification command) (YES in step S110), and resets the timer 13 in step S111. Further, in the case in which there is no sending of the notification command from the communication adapter 20, as in the above manner, the timer 13 afterward times out. In this case, upon determination of timing-out in step S113 (YES in step S113), the control unit 11 in step S114 causes transition to the safe operation state. That is to say, due to detection of the interruption of communication in the remote operation state, the main function control module 11c causes the main function of the household apparatus 10 to transition to the safe operation state.

In this manner, there is determined to be an interruption of communication with the management apparatus (controller 30) requesting or mediating the remote operation, including the in-home operation such as an operation sent to the household apparatus 10 disposed in a separate room and not limited to the outside-home operation when the operation request is sent via the in-home network 80. Then upon interruption of communication with the management apparatus in this manner, the household apparatus 10 transitions to the safe operation state. As a result, the uncontrollable state can be appropriately determined, and the household apparatus 10 can be made to transition to the safe operation state.

Although the aforementioned embodiments describe the case in which dedicated household apparatuses 10 and 60 are used, by using an existing personal computer, information terminal apparatus, or the like to run an operational program stipulating operation of these household apparatuses 10 and 60, the personal computer or the like can be made to function as the household apparatuses 10 and 60 according to the present disclosure.

Further, any method may be used for distribution of such a program, and for example, the program may be stored in a computer-readable recording medium such as a compact disc read-only memory (CD-ROM), a digital versatile disc (DVD), a magneto-optical (MO) disc, a memory card, or the like, and then the computer-readable recording medium storing the program may be distributed through a communication network such as the Internet.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL AVAILABILITY

The present disclosure is capable of use with advantage for a household apparatus capable of appropriately distinguishing an uncontrollable state and causing transition of the household apparatus to safe operation state, and for a communication adapter, a control method, and a program.

### REFERENCE SIGNS LIST

1 Home system
10, 60 Household apparatus
10a Remote control unit
20 Communication adapter
30 Controller
40 Server
50 Communication terminal
80 In-home network
90 Outside-home network

1. A household apparatus controlled by a remote operation via a network, the household apparatus comprising:
a communication unit configured to perform communication via an in-home network including a plurality of controllers, each controller of the plurality of controllers being capable of being a management apparatus;
a storage;
a registration unit configured to register in the storage identification information for identifying a controller requesting or mediating a remote operation when the remote operation is performed; and
a state control unit configured to, when communication with a controller for which identification information registered in the storage matches is interrupted in a remote operation state, cause transition of the household apparatus to a predetermined safe operation state, the remote operation state being a state in which the remote operation is performed.

2. The household apparatus according to claim 1, further comprising:
a timing unit configured to measure a non-communication time, the non-communication time being an elapsed time period free of communication by the communication unit; and
a timing control unit configured to, when the communication performed by the communication unit is with the controller for which identification information registered in the storage matches, reset the non-communication time measured by the timing unit to an initial value,
wherein the state control unit causes the transition of the household apparatus to the safe operation state when the non-communication time measured by the timing unit exceeds a predetermined reference value.

3. (canceled)

4. The household apparatus according to claim 2, further comprising:
an inputter configured to receive an in-home operation from within a home,
wherein, when the inputter receives the in-home operation, the timing control unit causes the timing unit to stop and the state control unit causes a change of the household apparatus from the remote operation state to an in-home operation state.

5. The household apparatus according to claim 2, wherein
the in-home network includes another apparatus,
the communication unit is capable of receiving an in-home operation sent from the other apparatus, and
when the communication unit receives the in-home operation, the timing control unit causes the timing unit to stop and the state control unit causes a change of the household apparatus from the remote operation state to an in-home operation state.

6. A communication adapter for relaying a remote operation to a household apparatus via a network, wherein
the household apparatus:
measures a non-communication time in a remote operation state in which the remote operation is performed, the non-communication time being an elapsed time period free of communication; and
transitions to a safe operation state when the non-communication time exceeds a predetermined reference value, and
the communication adapter comprises:
a communication unit configured to perform communication via an in-home network including a plurality of controllers, each controller of the plurality of controllers being capable of being a management apparatus;
a storage;
a registration unit configured to register in the storage identification information for identifying a controller requesting or mediating the remote operation when the remote operation is performed; and
a command transmitter configured to, when the communication performed by the communication unit is with a controller for which identification information registered in the storage matches, transmit to the household apparatus a command for causing the non-communication time to reset to an initial value.

7. A control method for controlling a household apparatus by a remote operation via an outside-home network, the control method comprising:
communicating via an in-home network including a plurality of controllers, each controller of the plurality of controllers being capable of being a management apparatus;
registering in a storage identification information for identifying a controller requesting or mediating the remote operation when the remote operation is performed; and
transitioning the household apparatus to a predetermined safe operation state when communication with a controller for which identification information registered in the storage matches is interrupted in a remote operation state, the remote operation state being a state in which the remote operation is performed.

8. A non-transitory computer-readable recording medium storing a program for causing a computer controlled by a remote operation via a network to function as:
a communication unit configured to perform communication via an in-home network including a plurality of controllers, each controller of the plurality of controllers being capable of being a management apparatus;
a storage;
a registration unit configured to register in the storage identification information for identifying a controller requesting or mediating the remote operation when the remote operation is performed; and
a state control unit configured to, when communication with a controller for which identification information registered in the storage matches is interrupted in a remote operation state, cause transition to a predetermined safe operation state, the remote operation state being a state in which the remote operation is performed.
